(19) United States
(12) Patent Application Publication
(10) Pub. No.: US 2024/0150162 A1
(43) Pub. Date: May 9, 2024

(54) Cable Tie Handle

(71) Applicant: Panduit Corp., Tinley Park, IL (US)

(72) Inventor: David J. Sylvester, Manhattan, IL (US)

(73) Assignee: Panduit Corp., Tinley Park, IL (US)

(21) Appl. No.: 17/981,776

(22) Filed: Nov. 7, 2022

(51) Int. Cl. B66F 11/00; B65D 63/10; B65D 63/18

(52) U.S. Cl. CPC B66F 11/00; B65D 63/1027; B65D 63/18

(57) ABSTRACT

A cable tie handle wrapped around an object to aid a user in lifting or carrying the object. The cable tie handle has a cable tie head, a cable tie body, and a grip handle. The cable tie head has a strap passageway extending through the cable tie head. The cable tie body extends from the cable tie head. The cable tie body has an end for feeding into the strap passageway to form a loop. The grip handle is molded with the cable tie body. The grip handle has a plurality of projections for forming an easy to grip surface when the cable tie body is feed through the cable tie head.

### FIELD OF THE INVENTION

The present invention relates to a cable tie, and more particularly to a cable tie used as a handle for lifting or carrying objects.

### BACKGROUND OF THE INVENTION

Individuals often are required to move large objects that have a hard-to-reach handle, a handle that is hard to grasp, or no handle. Without a handle or area to grasp, moving a large object can be difficult.

It is desirable to provide a quick and simple handle that may be easily installed on various sized objects to assist individuals in grasping and moving the object.

### SUMMARY OF THE INVENTION

A cable tie handle designed to loop around an object to enable a user to lift or carry the object. The cable tie handle has a cable tie head, a cable tie body, and a grip handle. The cable tie head has a strap passageway extending through the cable tie head. The cable tie body extends from the cable tie head. The cable tie body includes an end that is fed into the strap passageway to form a loop. The grip handle is molded with the cable tie body. The grip handle has a plurality of projections that form an easy to grip surface when the cable tie body is feed into the cable tie head.

### BRIEF DESCRIPTION OF THE DRAWINGS

FIG. 1 is a perspective view of the cable tie with a grip handle of the present invention.

FIG. 2 is a side view of the cable tie with the grip handle of FIG. 1.

FIG. 3 is a top view of the cable tie with the grip handle of FIG. 1.

FIG. 4 is a side view of the cable tie with the grip handle of FIG. 1 with the end of the cable tie feed through the cable tie head.

FIG. 5 is a perspective view of the cable tie with the grip handle of FIG. 4.

FIG. 6 is a perspective view of two cable ties with the grip handles of FIG. 1 installed on a large rectangular package.

FIG. 7 is a perspective view of the cable tie with the grip handle of FIG. 1 installed on a large rectangular package.

FIG. 8 is a perspective view of the cable tie with the grip handle of FIG. 1 installed around a bundle of pipes.

FIG. 9 is a perspective view of the cable tie with the grip handle of FIG. 1 installed around a cable tie that has secured a bundle of pipes.

### DETAILED DESCRIPTION

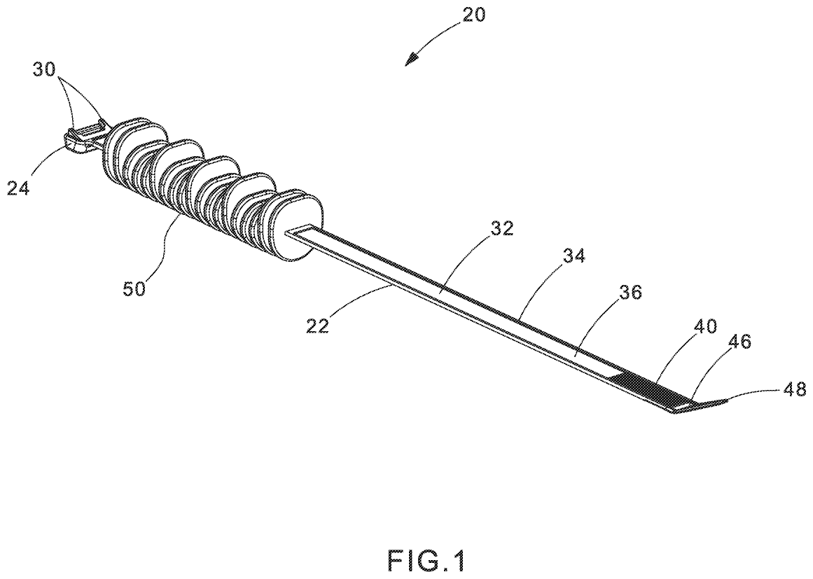

FIG. 1 is a perspective view of the cable tie with a grip handle 20 of the present invention. The cable tie with the grip handle 20 is a wide strap cable tie 22 with a cable tie head 24, cable tie body 32, and an end 46 with a bent tip 48. The cable tie body 32 includes side rails 34, a first side 36, and a second side 38. The first side 36 of the cable tie body 32 includes a plurality of teeth 40 positioned near the end 46 of the cable tie 22.

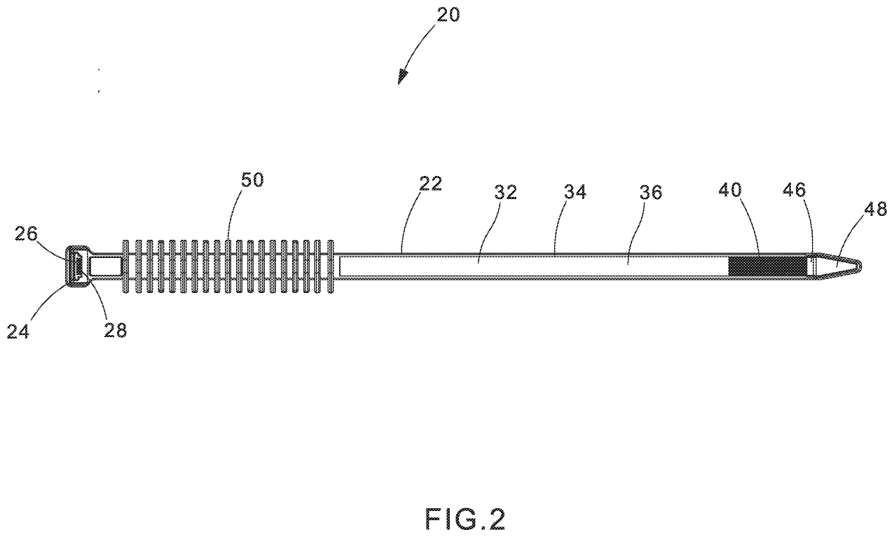

As illustrated in FIG. 2, the second side 38 of the cable tie body 32 includes a bump stop 42. The bump stop 42 is a molded protrusion that extends outwardly from the cable tie body 32. The bump stop 42 helps to control the pulling of the cable tie body 32 through the cable tie head 24. The bump stop 42 prevents the cable tie body 32 from being pulled too far thru the cable tie head 24. The bump stop 42 ensures there is plenty of space between the object to be carried and the grip handle 50 to allow the user to hold on to the grip handle 50.

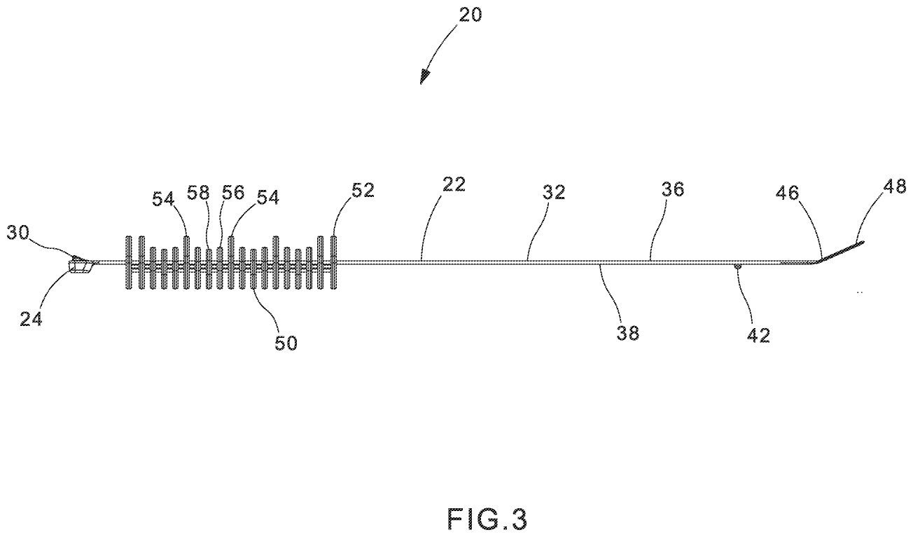

As illustrated in FIG. 3, the cable tie head 24 includes a strap passageway 26 through the cable tie head 24 and a locking wedge 28 that extends into the strap passageway 26. The cable tie head 24 also includes clamping rails 30 for positioning the cable tie body 32 after it has been partially pulled through the strap passageway 26. When the cable tie body 32 is feed through the strap passageway 26, the locking wedge 28 engages the teeth 40 on the first side 36 of the cable tie body 32. The cable tie body 32 forms a loop with the grip handle 50 at one end as the cable tie body 32 is pulled through the strap passageway 26 until the bump stop 42 prevents further movement.

As illustrated in FIGS. 1-5, the cable tie body 32 includes a grip handle 50 that is molded with the cable tie. The grip handle 50 includes a plurality of projections 52 of various heights that form a surface for the user to easily grip. The projections 52 have smooth rounded edges to provide an ergonomic surface. As illustrated in FIG. 2, the plurality of projections 52 form a pattern that accommodate the user's fingers to enable the user to firmly grip the handle. As illustrated in FIG. 3, the projections form an alternative pattern of higher or taller projections 54 followed by shorter projections 56, 58 and then back to the taller projections 54 thereby defining areas for the user's fingers. Although one alternating pattern has been illustrated, the projections 52 could be molded in various ergonomic patterns to accommodate the user's hand.

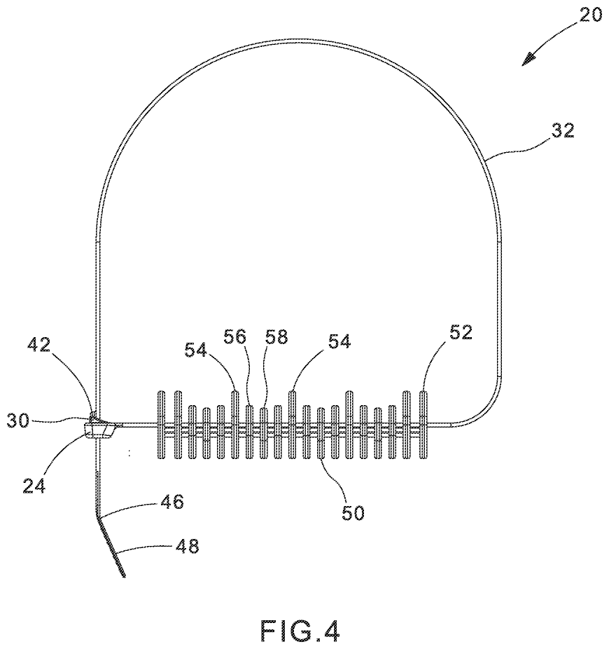

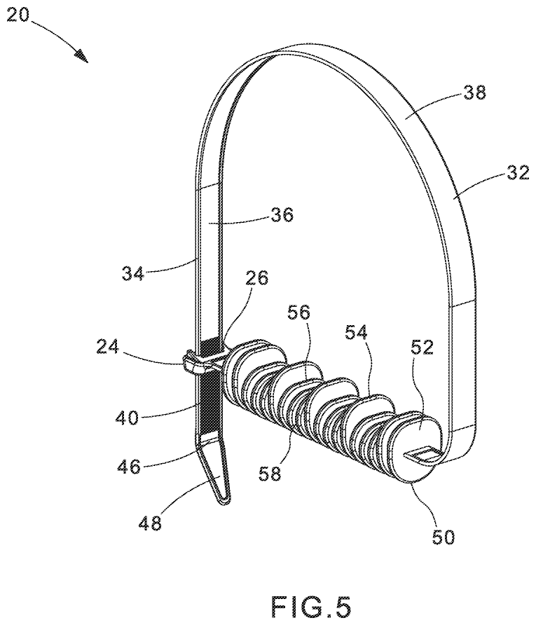

As illustrated in FIGS. 4 and 5, the cable tie end 46 is feed through the strap passageway 26 in the cable tie head 24. The cable tie body 32 can be pulled thru the strap passageway 26 until the bump stop 42 is engaged. At that point, the cable tie 22 has formed a handle which can be easily gripped by the user.

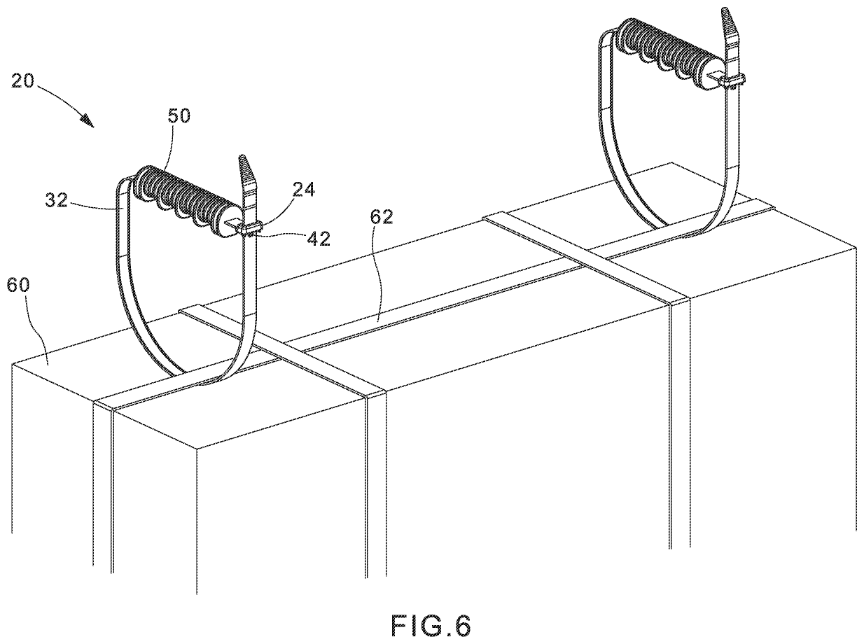

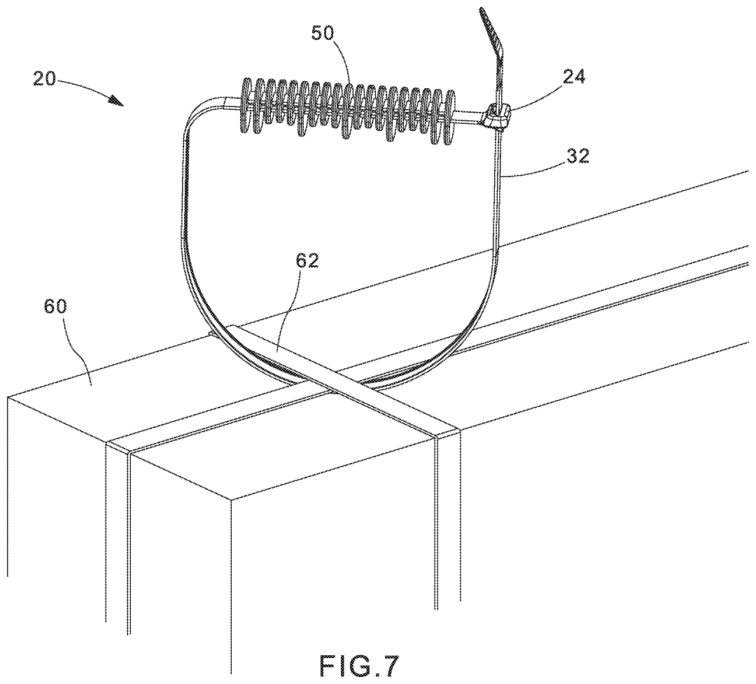

FIGS. 6-9 illustrate examples of the cable tie with the grip handle 20 installed on hard to carry objects. FIG. 6 illustrates a rectangular package 60 with packaging straps 62 wrapped around the rectangular package 60. Often the packaging straps 62 are installed too tightly around the package 60 for a user to grip the packaging straps 62 to carry the package 60. Also, the packaging straps 62 can have sharp edges that can injure a user if they try to grip the straps with bare hands. The cable tie with the grip handle 20 of the present invention can be easily installed on the packaging straps 62. To install the cable tie with the grip handle 20, the end 46 of the cable tie 22 slides under the packaging strap 62 and is feed through the cable tie head 24 until the bump stop 42 hits the entrance of the strap passageway 26. As illustrated in FIG. 6, a second cable tie with the grip handle 20 is installed on the package 60 to facilitate carrying the package 60. FIG. 7 illustrates the cable tie with the grip handle 20 installed on the package 60 in an alternative position. Instead of being placed under one packaging strap 62, the cable tie with the grip handle 20 can be feed under the intersection of multiple packaging straps. A user may install the cable tie with the grip handle 20 where desired to facilitate gripping and carrying the object.

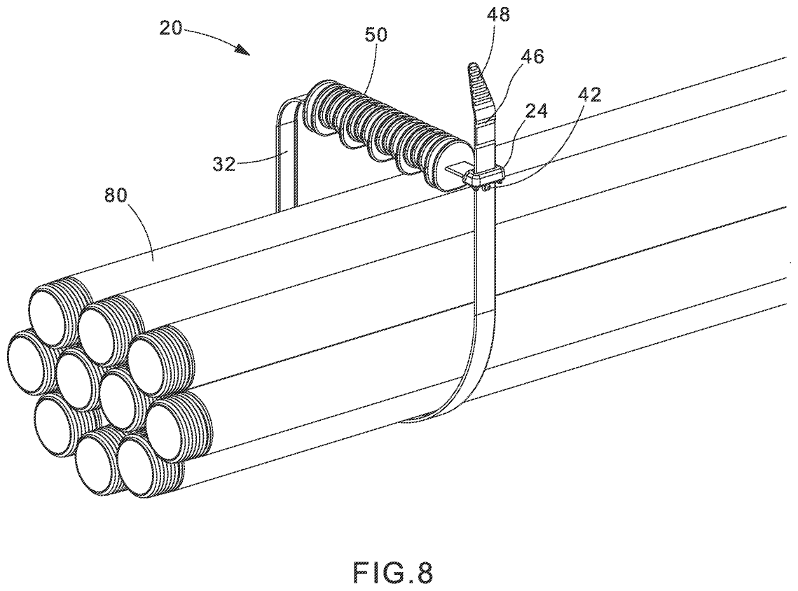

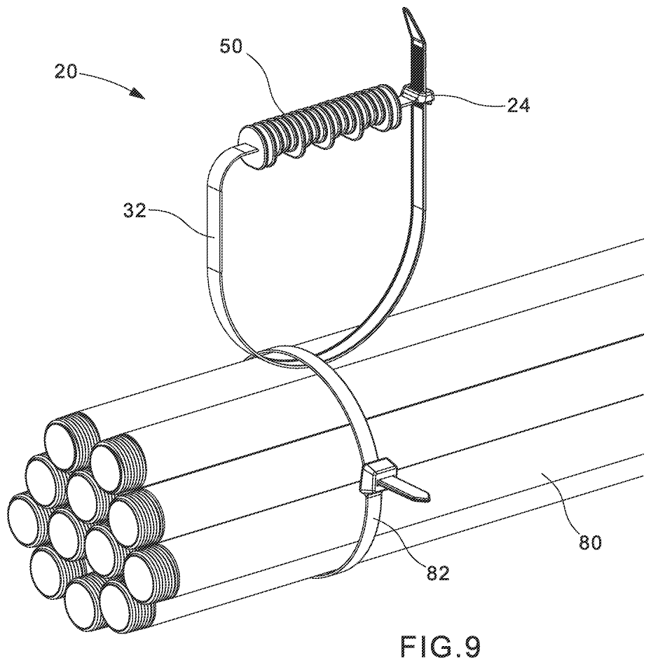

FIGS. 8 and 9 illustrate the cable tie with the grip handle 20 installed to carry a bundle of pipes 80. As illustrated in FIG. 8, the cable tie with the grip handle 20 may wrap around the bundle of pipes. Alternatively, as illustrated in FIG. 9, a typical cable tie 82 may be secured around the bundle of pipes and the cable tie with the grip handle 20 of the present invention maybe feed under the cable tie 82 and secured thereby creating a handle to carry the bundle of pipes.

Furthermore, while the preferred embodiments of the present invention have been shown and described, it will be obvious to those skilled in the art that changes and modifications may be made without departing from the teaching of the invention. The matter set forth in the foregoing description and accompanying drawings is offered by way of illustration only and not as limitation. The actual scope of the invention is intended to be defined in the following claims when viewed in their proper perspective based on the prior art.

What is claimed is:

1. A cable tie handle for enabling an object to be lifted, the cable tie handle comprising:
a cable tie head with a strap passageway extending through the cable tie head;
a cable tie body extending from the cable tie head, wherein the cable tie body having an end for feeding into the strap passageway to form a loop; and
a grip handle molded with the cable tie body, wherein the grip handle has a plurality of projections for forming an easy to grip surface.

2. The cable tie handle of claim 1, wherein the plurality of projections have various heights forming a pattern to accommodate holding the grip handle.

3. The cable tie handle of claim 1, wherein the cable tie body having teeth and the strap passageway having a locking wedge that engages the teeth on the cable tie body.

4. The cable tie handle of claim 1, wherein the cable tie body having a bump stop extending outwardly from one side of the cable tie body.

5. The cable tie handle of claim 4, wherein the bump stop prevents the cable tie body from being pulled through the cable tie head.

6. The cable tie handle of claim 1, wherein the cable tie body having a first side and a second side, wherein the cable tie body having teeth on the first side and a bump stop on the second side.

7. The cable tie handle of claim 6, wherein the bump stop is a projection extending outwardly from the second side of the cable tie body.

8. The cable tie handle of claim 6, wherein the bump stop prevents the cable tie body from being pulled through the cable tie head.
